(19) United States
(12) Patent Application Publication
(10) Pub. No.: US 2015/0328711 A1
(43) Pub. Date: Nov. 19, 2015

(54) RESISTANCE-WELDER POWER SOURCE AND RESISTANCE WELDER USING THE SAME

(71) Applicant: ELM Inc., Kagoshima (JP)

(72) Inventor: Takakazu Miyahara, Kagoshima (JP)

(73) Assignee: ELM Inc., Kagoshima (JP)

(21) Appl. No.: 14/443,979

(22) PCT Filed: Nov. 5, 2013
(86) PCT No.: PCT/JP2013/079907

§ 371 Date: Aug. 5, 2015

(30) Foreign Application Priority Data
Nov. 20, 2012 (JP) 2012-254447

(51) Int. Cl. B23K 11/24

(52) U.S. Cl. CPC B23K 11/241

(57) ABSTRACT

Provided is a power source for energizing a resistance welder, including: one or a plurality of lithium-based secondary batteries (11); a charging circuit (13) for charging the lithium-based secondary battery using an external power source; and a power conversion circuit (e.g. DC-DC converter (12)) for converting DC power discharged from the lithium-based secondary battery (11) into DC or AC power having a predetermined level of maximum instantaneous power for energizing the resistance welder.

### TECHNICAL FIELD

The present invention relates to a power source for a resistance welder (in particular, a spot welder) used for welding stacked metallic plates, metallic wires or the like, as well as a resistance welder using that power source.

### BACKGROUND ART

Resistance welders popularly used for welding stacked metallic plates, metallic wires or the like are also called spot welders. Objects to be welded are held between two electrodes and a direct or alternating current is passed through them. As a result, heat is generated due to the electrical resistance of the objects against the current, whereby the objects become melted and are eventually welded together.

During this task, the thermal changes in color and nature can be limited to the welded point by completing the welding in such a short period of time as to prevent the heat from spreading into the surrounding area. The denaturing of each welded point is also slight, while the working efficiency is extremely high.

### CITATION LIST

### Patent Literature

Patent Literature 1: JP 2003-136240 A

### SUMMARY OF INVENTION

### Technical Problem

To complete the welding in such an extremely short period of time, a significantly large amount of energy capable of melting the objects to be welded must be applied within a short period of time. Conventional resistance welders require an electric power of a few kW up to 100 kW during the welding process. Therefore, a considerably large power source is needed.

In a first method for realizing a power source for conventional resistance welders, a transformer capable of supplying the necessary amount of power is used and its primary side (which requires less current) is controlled by a phase control or similar technique. In general, the welding time is said to be “the thickness (mm)×10 cycles of the commercial alternating current” and thereby extremely short. However, since some preparatory work requires a few seconds to several tens of seconds before the strict welding time, the duty ratio (i.e. the welding time/the entire working time) is as low as 1/100 to 1/1000. Therefore, for example, if the maximum instantaneous power is 10 kW and the duty ratio is 1/100, although the average power is only 100 W, a transformer capable of supplying the maximum instantaneous power of 10 kW is actually required, together with an external power source capable of supplying this power, such as a commercial power supply or generator. The transformer alone weighs as much as 20 to 30 kg. Even a small-sized “portable” resistance welder requires a maximum amount of instantaneous power which exceeds a few kW.

Therefore, in this conventional method, the power cannot be obtained from commonly used sockets, and cumbersome electrical work is required. Furthermore, the use of a heavy transformer deteriorates portability. Since the main unit is difficult to move, the cable for supplying electric current from the main unit to the welding unit must be considerably long. To pass a few thousand to several ten thousand amperes of current through such a long cable, it is necessary to use a thick cable having a low electrical resistance, which further lowers the working efficiency in the case of a portable welder.

Patent Literature 1 discloses a welder which is made to be portable by using a rear-car type vehicle carrying a lead storage battery, transformer and other devices. In this system, electric power is temporarily stored in the lead storage battery before the current is supplied to the welding unit through the transformer. Therefore, the maximum instantaneous power to be supplied from an external source can be decreased. However, since the lead storage battery has a low capacity, it is difficult to sufficiently increase the maximum instantaneous power used in the welding process. Furthermore, the lead storage battery and the transformer are very heavy and need to be mounted on a vehicle in the aforementioned way. Such a system cannot be used as a handy welder that can be entirely hand-carried by a user or fastened to the waist or other parts of the user's body when in use.

A second method for realizing a power source for conventional resistance welders is the so-called inverter system. In this method, electric power supplied from an external source is initially rectified into DC power and subsequently turned on and off at high speeds by a semiconductor switch to generate radio-frequency power. Then, the voltage of this power is decreased by a radio-frequency transformer, and the obtained power is supplied to the welding unit. This method is advantageous in that a small-size transformer can be used and the electric current or the like can be controlled at high speeds. However, a dramatic reduction in size is difficult to achieve. Furthermore, the previously described problem of a large difference between the average power and the maximum instantaneous power is left unsolved.

The present invention solves the previously described problems in the resistance welder and provides a resistance-welder power source which is far smaller and lighter than conventional resistance-welder power sources and which requires only a considerably low level of maximum instantaneous power to be supplied from an external source, as well as a resistance welder using such a power source.

### Solution to Problem

A resistance-welder power source developed for solving the previously described problem is a power source for energizing a resistance welder, the power source including:
a) one or a plurality of lithium-based secondary batteries;
b) a charging circuit for charging the lithium-based secondary battery using an external power source; and
c) a power conversion circuit for converting DC power discharged from the lithium-based battery into DC or AC power having a predetermined level of maximum instantaneous power for energizing the resistance welder.

The resistance-welder power source according to the present invention employs a lithium-based secondary battery capable of instantaneously discharging an amount of current 20 to 100 times as high as the rated current. In recent years, such a battery has been popularly used in radio control cars, airplanes, helicopters and others. The battery can be charged during the waiting time which is more than 100 times as long as the welding time, whereby the average power as viewed from an external power source (e.g. a commercial power supply or generator) can be decreased to 1/100 or lower. Since such a low level of power can be supplied from a commonly used household wall socket, no cumbersome electrical work is necessary. The scale of electrical components related to an external power supply can be dramatically reduced. Furthermore, the power can be supplied through a commonly used extension cable. These and other features significantly improve the user-friendliness in portable applications.

The performance of lithium-based secondary batteries that can be used in the resistance-welder power source according to the present invention is noticeably improving. It would seem that secondary batteries with even higher performances will be developed in the future. One example of the performance achieved to date is as follows: In the case of the popularly used lithium polymer battery which is generally called the LiPo battery, the output voltage is approximately 3.7 V per one cell. For example, it measures 50 mm in width, 130 mm in length, 9 mm in thickness, and weighs 125 g. Its rated ampacity is 5 Ah, with a maximum output current of 20 to 50 times as high as the rated current. A current as high as approximately 1.5 times the maximum output can be extracted for a short period of 10 seconds or less.

In resistance-welder power sources, the welding time is extremely short, while the idle time is extremely long. A LiPo battery having a rated ampacity of 5 Ah and discharge capacity of 75 C (the discharge capacity is the amount of current that can be instantaneously supplied, represented by a multiple of the rated ampacity, C) allows a current of 375 A to be extracted. Connecting 14 pieces of LiPo batteries in parallel results in a power source with a maximum output current of approximately 5000 A. To extract a controlled amount of power necessary for the resistance welding from such a power source using a plurality of batteries, the following three configurations can be adopted. Examples of the configurations are hereinafter described.

In the first configuration, each of the plurality of batteries is provided with one chopper-type DC-DC converter as a power conversion circuit, and the outputs of these converters are combined. Furthermore, a controller for a collective control of the DC-DC converters is provided. There are two methods for the collective control of the DC-DC converters. In one method, the DC-DC converters are electrically connected in parallel. In another method, each individual DC-DC converter is provided with a control circuit, and control conditions are given to the control circuits through communication channels or other means, leaving only the ON/OFF operation of the converters to be collectively controlled.

One merit of this configuration is that, even if a problem occurs in some of the batteries, the welding function can be maintained by removing those units, although the maximum output decreases. Another merit is that the batteries can be easily charged since they are connected in parallel.

In the second configuration, the batteries are connected in parallel, and their outputs are controlled by a single high-current DC-DC converter.

The present configuration is similar to the first configuration in terms of some merits. For example, even if a problem occurs in some of the batteries, the welding function can be maintained, even with a decreased maximum output, by removing those units, and furthermore, the batteries can be easily charged since they are connected in parallel. Another merit, which cannot be found in the first configuration, is that the configuration becomes simpler, less expensive, and less likely to cause a failure since only one DC-DC converter is used. It should be noted that the second configuration needs special electronic components (semiconductors, coils, etc.) for the collective control of a current which reaches up to 5000 A, and that a heat-removing device is necessary since an intensive amount of heat is generated.

In the third configuration, a plurality of batteries are connected in series, and their outputs are controlled by a single high-current DC-DC converter.

Similarly to the first and second configurations, the present configuration has the merit that, even if a problem occurs in some of the batteries, the welding function can be maintained by removing those units and bypassing the units, although the maximum output decreases. Furthermore, similarly to the second configuration, the present configuration is simple since only one control circuit is used. Additionally, an advantage specific to the third configuration exists in that the size of the DC-DC converter can be easily reduced, since the amount of current to be controlled to produce a predetermined power is reduced to 1/N (where N is the number of batteries). However, in the process of charging the batteries connected in series, a voltage difference accumulates due to the slight differences in the capacities of the batteries. Therefore, a circuit for balancing the voltage difference should preferably be added.

The description thus far has assumed the use of a DC-DC converter as an example of the power conversion circuit. The present invention also allows the use of an inverter for converting a DC current into AC current.

Hereinafter considered is a cable for connecting the resistance-welder power source according to the present invention and a welding head. For example, a copper wire with a sectional area of 100 mm² (a conductor diameter of 15.2 mm) has a resistance of approximately 0.18 mΩ per one meter. If one meter of this wire is used on both the positive and negative sides, the resistance of the entire wire will be 0.36 mΩ. Passing a welding current of 5 kA through this wire causes a voltage drop of 1.8 V. According to the present invention, the resistance-welder power source can be so small and so light that the resistance welder can be placed near the site of the welding work or fastened to the worker's body, which allows the use of a shorter cable and consequently reduces the voltage drop. Therefore, the output voltage of the power source can be lowered, and furthermore, the loss of the power in the cable is reduced.

### Advantageous Effects of the Invention

According to the present invention, a small and lightweight power source for a resistance welder can be obtained. By using this resistance-welder power source, a highly portable resistance welder can be obtained. Therefore, it is possible to entirely solve various problems (such as poor operability, cumbersome preparation task, or unavailability for high-place work) arising from the use of conventional power sources in various kinds of work which require portability (e.g. the fixation of reinforcement bars in a site of construction/civil-engineering work, sheet-metal repairing of an automobile, manual stud welding, or the fixation of wires for wall greening).

The power to be supplied can be obtained from household outlets or similar common sources. A generally available tough-rubber sheath cable can be used as the connection cable. The light weight allows an easy-to-carry design, such as a backpack form. Owing to these features, the present power source requires almost no preparation work and can be operated with a small generator, so that the range of applications is considerably expanded.

The lithium-based secondary battery can instantaneously discharge the required amount of high current, while the charging of the lithium-based secondary battery requires only a low level of maximum instantaneous power to be supplied from an external source. This contributes to the cost reduction, since it allows the lowering of the contracted demand of the commercial power supply as well as the use of a receiving facility smaller in size and lower in capacity. It should be noted that this effect is not limited to the aforementioned applications which require a reduced size and improved portability.

### BRIEF DESCRIPTION OF DRAWINGS

FIG. 1 is a circuit diagram showing one embodiment of the resistance-welder power source according to the present invention.

FIG. 2 is a circuit diagram showing a modified example of the resistance-welder power source of the present embodiment.

FIG. 3 is (a) a graph showing the temporal change of a trigger signal, a gate voltage applied to a gate electrode, and an output voltage supplied to a load (resistance welder) in the resistance-welder power source of the present embodiment, and (b) a graph showing a portion of graph (a) in a temporally stretched form.

FIG. 4 is a schematic perspective view showing one actual example of the resistance-welder power source of the present embodiment.

FIG. 5 is a schematic diagram showing one example with a plurality of unit power sources connected in parallel.

FIG. 6 is a schematic diagram showing one actual example with a plurality of unit power sources connected in parallel.

FIG. 7A is a circuit diagram showing one example of the resistance-welder power source with a plurality of LiPo batteries connected in parallel, and FIG. 7B is a circuit diagram showing one example of the resistance-welder power source with a plurality of LiPo batteries connected in series.

### DESCRIPTION OF EMBODIMENTS

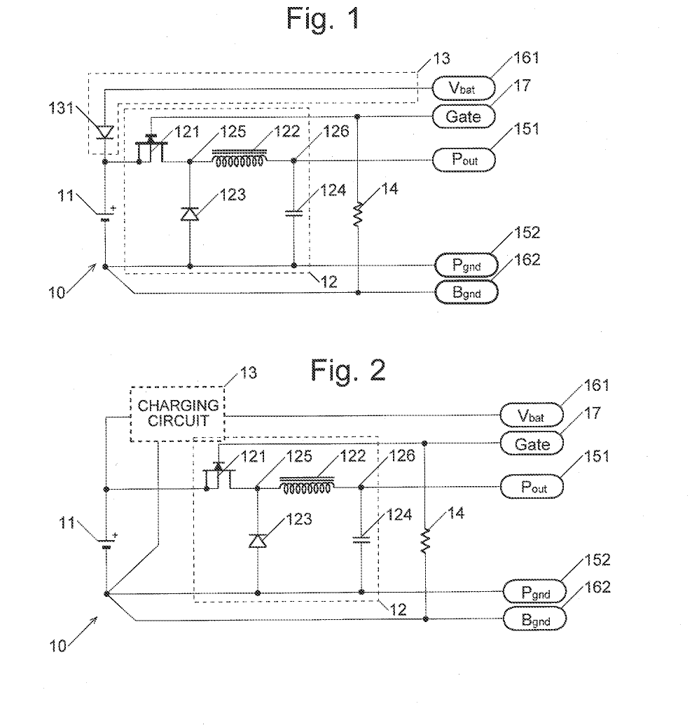

Embodiments of the resistance-welder power source and the resistance welder according to the present invention are hereinafter described using FIGS. 1-7B.

### Embodiments

As shown in the circuit diagram of FIG. 1, the resistance-welder power source 10 of the present embodiment has a LiPo battery (which is a kind of lithium-based secondary battery), a DC-DC converter (power conversion circuit) 12 and a charging circuit 13. Furthermore, the resistance-welder power source 10 is provided with: a power output terminal 151 and a power-supply-side grounding terminal 152, both of which are to be connected with a resistance welder as the load; an input terminal 161 for an external power source and a battery-grounding terminal 162, both of which are used for supplying electric current to the LiPo battery 11; and a gate terminal 17 to be connected to a gate electrode of a field-effect transistor 121 (which will be described later).

The DC-DC converter 12 has a field-effect transistor 121, coil (reactor) 122, reflux diode 123 and capacitor 124. The field-effect transistor 121 and coil 122 are connected in series between the positive electrode of the LiPo battery 11 and the power output terminal 151. The field-effect transistor 121 is used to turn on and off the current from the LiPo battery 11 according to the ON/OFF state of the voltage at the gate electrode. The reflux diode 123 connects the power-supply-side grounding terminal 152 with a connection point 125 located between the field-effect transistor 121 and the coil 122, so as to allow a current to pass through from the power-supply-side grounding terminal 152 to the connection point 125 while blocking the current in the opposite direction. The capacitor 124 connects the power-supply-side grounding terminal 152 with a connection point 126 located between the coil 122 and the power output terminal 151.

The charging circuit 13 supplies power from an external power source to the LiPo battery 11. It has a backflow-preventing diode 131 between the input terminal 161 for an external power source and the positive electrode of the LiPo battery 11 to prevent a backflow of the current from the LiPo battery 11 to the external power source. In particular, when a plurality of resistance-welder power sources 10 according to the present embodiment are connected in parallel with one external power source, the backflow of the current toward the external power source may occur due to the difference in electromotive force between the LiPo batteries 11 of the respective resistance-welder power sources 10. A commercially available charging circuit, such as an IC for charging a LiPo battery, can be directly used as the charging circuit 13 (FIG. 2).

Besides, the resistance-welder power source 10 is provided with an electrical resistance 14 connecting the gate electrode with the battery-grounding terminal 162 to which the negative electrode of the LiPo battery 11 is connected. The electrical resistance 14 prevents the field-effect transistor 121 from being erroneously turned on by static electricity or the like when the control module (which will be described later) is not connected to the gate electrode.

Besides, a CPU (not shown) for performing the control of sending a signal for turning on and off the voltage with a predetermined ON/OFF ratio is connected to the gate electrode. Details of this ON/OFF signal will be described later.

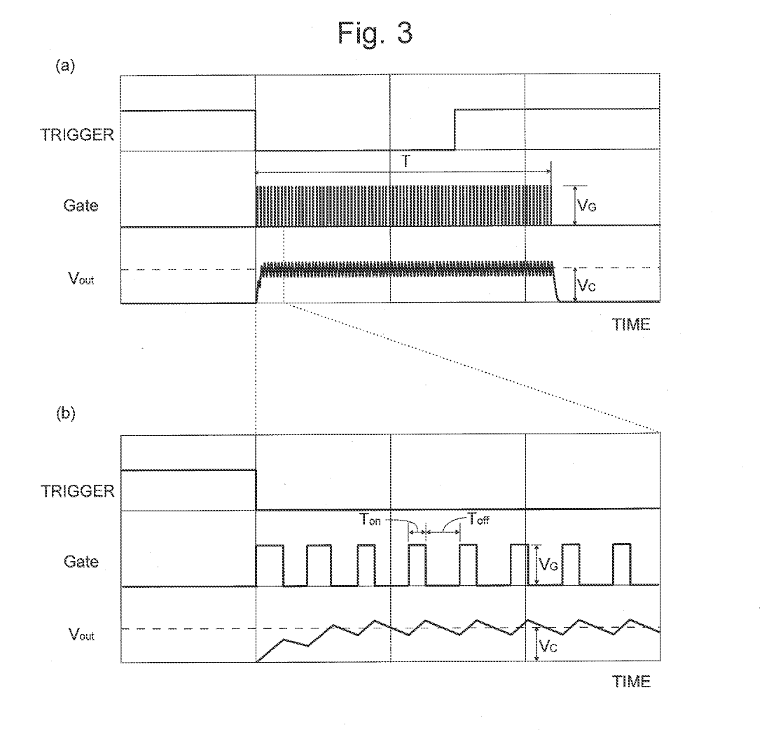

An operation of the resistance-welder power source 10 of the present embodiment is hereinafter described with reference to FIG. 3.

The LiPo battery 11 is charged by being supplied with a current from the input terminal 161 for an external power source. When a user operates a switch provided on the resistance welder, a trigger signal is sent from the switch to the CPU, whereby power is supplied from the DC-DC converter 12 to the resistance welder as follows.

Upon receiving the trigger signal, the CPU sends an ON/OFF signal to the gate electrode of the field-effect transistor 121 for a predetermined period of time T ((a) in FIG. 3). The “predetermined period of time T” is the period of time to supply power to the resistance welder. The “ON/OFF signal” is a signal in which an ON signal of voltage V_{G} and an OFF signal of voltage zero are alternately repeated as shown in (b) in FIG. 3. As will be explained later, the ratio of the period Tₒₙ of the ON signal to the period T_{off} of the OFF signal, i.e. the ON/OFF ratio (Tₒₙ/T_{off}), can be regulated by the CPU. The repetition frequency of the ON/OFF signal should preferably be higher than the human hearing range and hence equal to or higher than 20 kHz. Practically, the frequency is selected within a range from 20 kHz to several hundred kHz.

According to the ON/OFF signal, the field-effect transistor 121 turns on and off the power supplied from the LiPo battery 11 to the source electrode, and outputs a rectangular-wave power from the drain electrode. In the DC-DC converter 12, this rectangular-wave power is converted as follows: In the rising phase of the ON signal, the power suddenly increases. However, since this change is dampened by the reactance of the coil 122, and since a portion of the power is used to charge the capacitor 124, the increase in the output voltage Vₒᵤₜ from the DC-DC converter 12 is slow. On the other hand, during the period of the OFF signal, although no power is supplied from the drain electrode of the field-effect transistor 121, the power does not suddenly cease but decreases slowly, since the power produced by the coil 122 with a delay and the power accumulated in the capacitor 124 are supplied to the closed circuit passing through the load and the reflux diode 123. Thus, a direct-current (or pulsating-current, to be exact) power of voltage V_{C} (on average) is supplied from the DC-DC converter 12 to the load. Increasing the ON/OFF ratio of the rectangular wave power output from the drain electrode, i.e. the ON/OFF ratio Tₒₙ/T_{off} of the signal fed to the gate electrode, results in a higher output power from the DC-DC converter 12. It is possible to make the output voltage Vₒᵤₜ reach the target value V_{C} quickly by setting the ON/OFF ratio applied in the increasing phase of the output voltage Vₒᵤₜ at a higher value than the ratio which is applied after the target value V_{C} is reached.

In the previous embodiment, the reflex diode 123 is used. However, in the case of handling a high current, it is preferable to replace the reflex diode 123 with an active diode consisting of a field-effect transistor whose source and drain electrodes respectively serve as the anode and cathode of the diode, since this configuration has a lower loss of energy.

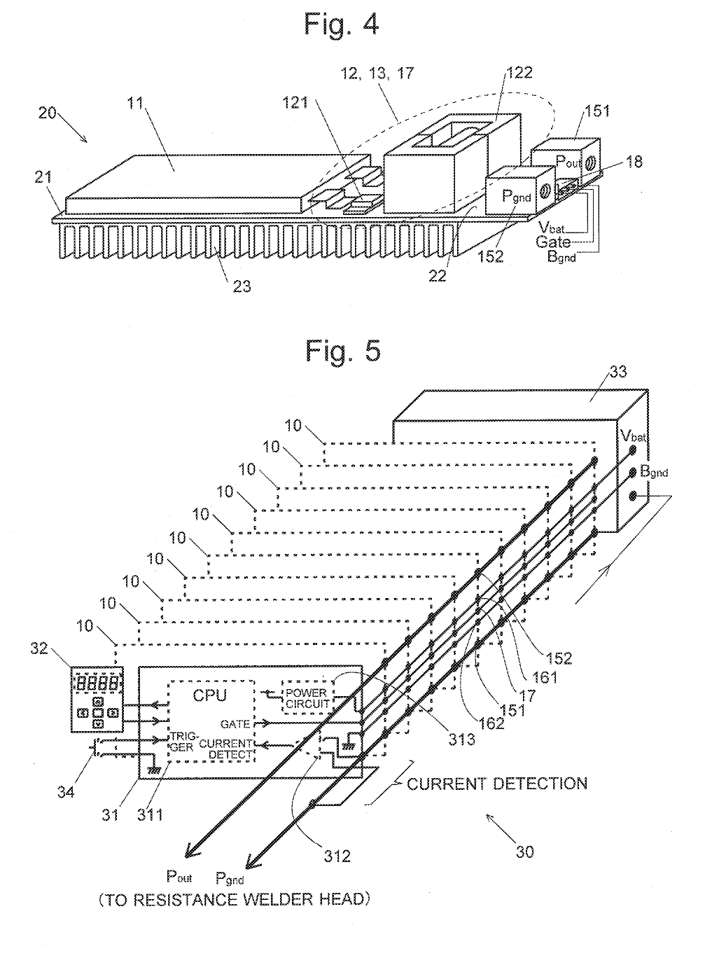

One example of the power module 20 in which the resistance-welder power source 10 of the present embodiment is actually used is hereinafter described using FIG. 4. This power module 20 has a rectangular base plate 21 having a high thermal conductivity, such as an aluminum plate, with the resistance-welder power source 10 mounted on one surface (mount surface 22) and a radiator 23 having a large number of fins on the other surface. The LiPo battery 11 as well as the field-effect transistor 121, coil 122, reflex diode 123 and other elements are mounted on the mount surface 22 in such a manner that each element is thermally in sufficient contact with the radiator 23 through the mount surface 22. It should be noted that the elements other than the field-effect transistor 121 and the coil 122 are located behind the coil 122 and hence not shown in FIG. 4.

A three-pin terminal 18 containing the input terminal 161 for an external power source, the battery-grounding terminal 162 and the gate terminal 17, is provided on the mount surface 22 near one of the short sides of the base plate 21. The power output terminal 151 and the power-supply-side grounding terminal 152 are separated from the three-pin terminal 18 on the mount surface 22 near the aforementioned short side of the base plate 21, since a higher current needs to be passed through those two terminals than through the other terminals. The power output terminal 151 and the power-supply-side grounding terminal 152 each have a hole with a female thread. By tightening a bolt in this hole, a wire leading to a resistance welder is fixed between the bolt and the terminal.

Among those elements mounted in the power module 20, the field-effect transistor 121 and the reflex diode 123 are the two elements which generate the largest amount of heat per unit area on the mount surface 22, followed by the coil 122. In the present power module 20, those elements which generate a large amount of heat are thermally in sufficient contact with the radiator 23, so that their heat can be efficiently dissipated from the radiator 23.

Thus far, an example of the resistance-welder power source 10 using a single LiPo battery 11 has been described. Even if a current of approximately 75 times as high as the rated ampacity can be instantaneously extracted, a huge LiPo battery 11 having the rated ampacity exceeding 50 Ah is needed to supply a maximum instantaneous power of several ten kW which is necessary for any resistance-welder power source. Given this problem, a plurality of resistance-welder power sources 10 (each individual resistance-welder power source 10 is hereinafter called the “unit power source 10”) can be used, whereby an amount of power with a maximum instantaneous level of several tens of kW can be supplied even if each individual LiPo battery 11 has a rated ampacity as low as several Ah. One example is hereinafter described.

The resistance-welder power source 30 shown in FIG. 5 includes ten unit power sources 10 connected in parallel with the load. The resistance-welder power source 30 is provided with a control module 31. The control module 31 includes a CPU 311 for the transmission control of the ON/OFF signal, a current measurement unit 312 for measuring the current supplied to the head of the resistance welder, and a power circuit 313 for supplying power for energizing the CPU 311 and other components from an AC power source 33. The current measurement unit 312 used in the present embodiment measures the current based on the potential difference between the upstream and downstream ends of a section of the power supply line (in the next embodiment, a grounding bar 352) connecting the resistance-welder power source 30 and the head of the resistance welder. A measurement unit employing some other method may also be used, such as the one using a Hall element.

The power output terminal 151 and the power-supply-side grounding terminal 152 of each unit power source 10 are respectively connected to the power input section (not shown) and the grounding electrode of the head of the resistance-welder. An AC power source 33 is connected to the input terminal 161 for an external power source of each unit power source 10. The grounding terminal of the AC power source 33 is connected to the battery-grounding terminal 162.

Connected to the CPU 311 are an operation panel 32 for setting the amount of power to be supplied to the head of the resistance welder and the period of time T to supply the power, as well as a switch 34 for sending a trigger signal.

In the present embodiment, a commonly available LiPo battery having a rated ampacity of 5 Ah and output voltage of 3.7 V is used as the LiPo battery 11 included in each individual unit power source 10. This LiPo battery 11 allows a current of 250 A (approximately 50 times the rated ampacity) to be extracted per unit, with the maximum instantaneous power supply being slightly lower than 1 kW. Accordingly, the resistance-welder power source 30 having ten LiPo batteries 11 is sufficiently capable of supplying a maximum instantaneous power of several kW. An amount of power with a maximum instantaneous level higher than 10 kW can also be supplied by adding more unit power sources 10.

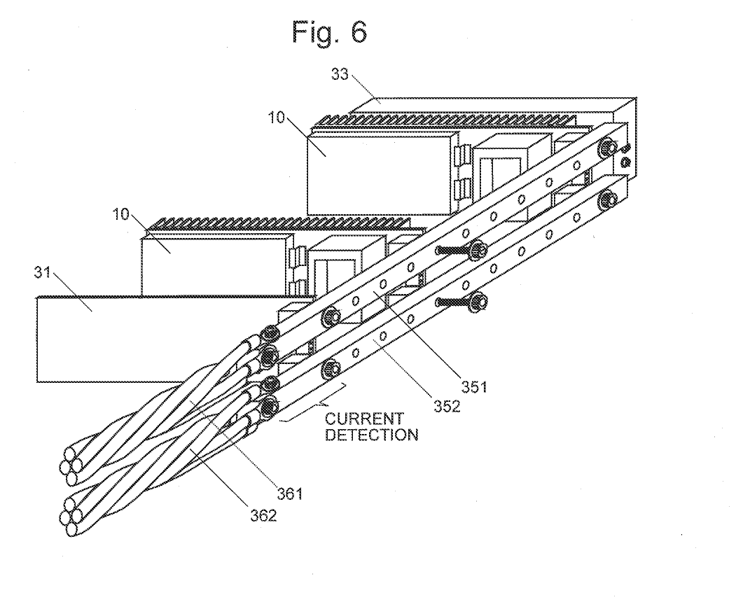

FIG. 6 shows one actual example of the resistance-welder power source 30 of FIG. 5. For simplicity, only two unit power sources 10 are shown in FIG. 6. Actually, ten units are provided, as in FIG. 5. The three-pin terminal 18 and the AC power source 33 are connected by common wires, although this connection is omitted in FIG. 6 for simplicity.

A power supply bar 351 consisting of a metallic bar is connected to the power output terminal 151 of each unit power source 10. The power supply bar 351 has a hole at each position corresponding to the power output terminal 151 of the unit power source 10. By aligning this hole with the aforementioned hole formed in the power output terminal 151 and joining them with a bolt, the power output terminal 151 is mechanically and electrically connected to the power supply bar 351. A power supply line 361 consisting of a bundle of metallic wires is connected to the power supply bar 351. The power supply line 361 is connected to the head of the resistance welder. The use of the power supply bar 351 consisting of a metallic bar and the power supply line 361 consisting of a bundle of metallic wires enables the supply of a large amount of current to the head of the resistance welder.

A grounding bar 352 consisting of a grounded metallic bar is connected to the power-supply-side grounding terminal 152 of each unit power source 10. The structure of the grounding bar 352 and the method of connection with the power-supply-side grounding terminal 152 are the same as the structure of the power output terminal 151 and the method of connection with the power supply bar 351. Furthermore, a grounding line 362 consisting of a bundle of metallic wires is connected to the grounding bar 352. The grounding line 362 is connected to the grounding terminal in the head of the resistance welder.

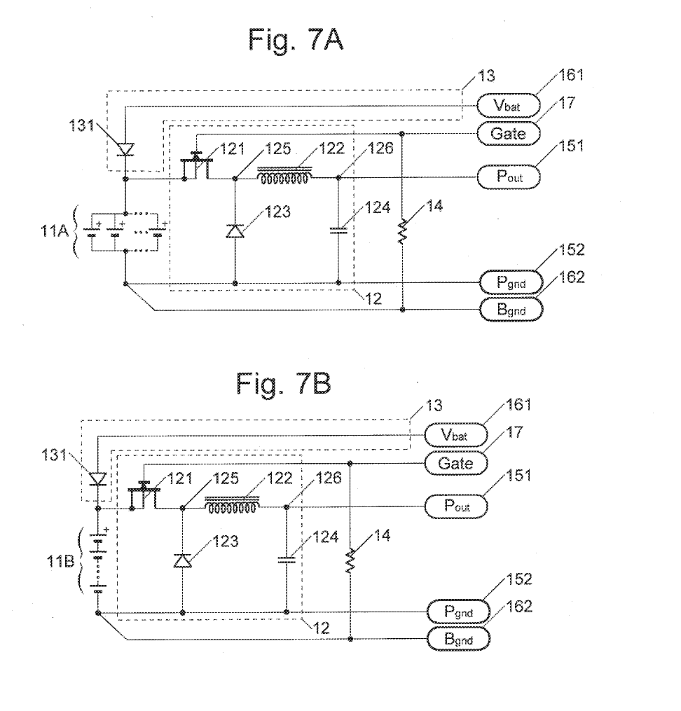

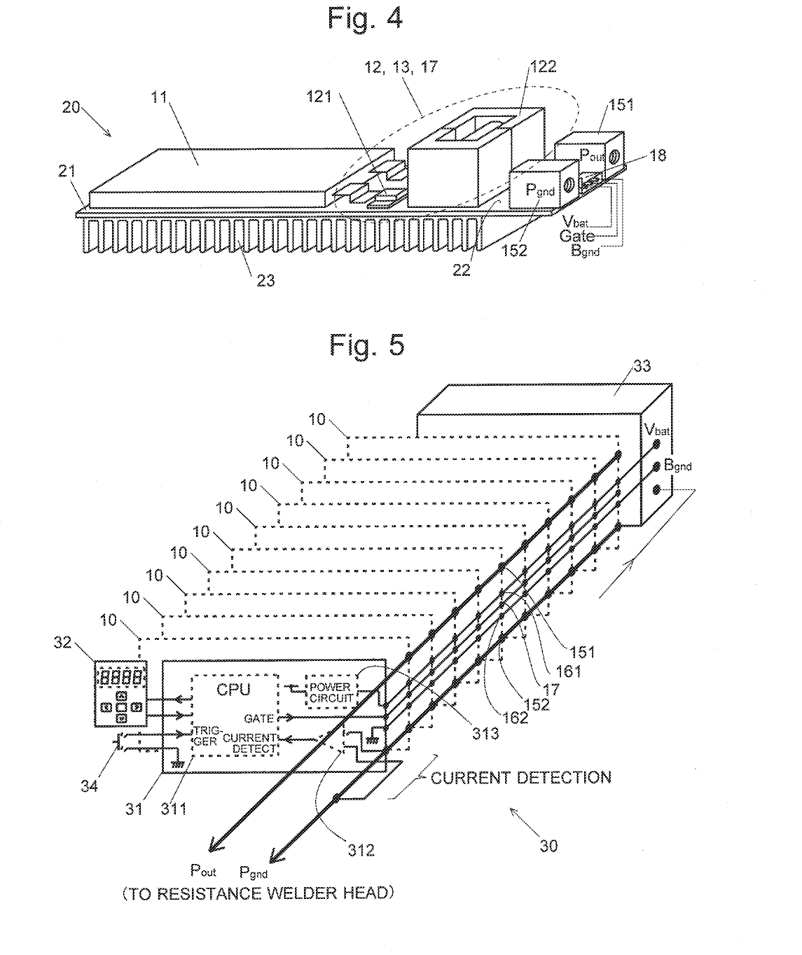

Thus far, the example of connecting a plurality of unit power sources 10 each having a single LiPo battery 11 has been described as an example of using a plurality of LiPo batteries 11. It is also possible to use a parallel-type LiPo battery group 11A having a plurality of LiPo batteries connected in parallel (FIG. 7A), or a serial-type LiPo battery group 1 lB having a plurality of LiPo batteries connected in series (FIG. 7B), in a circuit similar to the single-type resistance-welder power source 10 shown in FIG. 1 or 2. These examples require only one power conversion circuit (e.g. DC-DC converter 12). Therefore, the structure will be simpler and the device cost will be lower. In the case of the serial-type LiPo battery group 11B, the voltage is N-times higher than the other examples (where N is the number of cells in the LiPo batteries), so that the amount of current necessary for supplying the same amount of power will be reduced to 1/N.

A resistance-welder power source employing the parallel-type LiPo battery group 11A or the serial-type LiPo battery group 11B may be configured as a unit power source, and a plurality of such unit power sources may be connected in parallel, as shown in FIGS. 5 and 6.

In the examples described thus far, a DC-DC converter is used as the power conversion circuit. Alternatively, an inverter for converting DC power into AC power may be used.

### REFERENCE SIGNS LIST

10 . . . Resistance-Welder Power Source or Unit Power Source
11 . . . LiPo Battery
11A . . . Parallel-Type LiPo Battery Group
11B . . . Serial-Type LiPo Battery Group
12 . . . DC-DC Converter (Power Conversion Circuit)
121 . . . Field-Effect Transistor
122 . . . Coil
123 . . . Reflux Diode
124 . . . Capacitor
125, 126 . . . Connection Point
13 . . . Charging Circuit
131 . . . Backflow-Preventing Diode
14 . . . Electrical Resistance
151 . . . Power Output Terminal
152 . . . Power-Supply-Side Grounding Terminal
161 . . . Input Terminal
162 . . . Battery-Grounding Terminal
17 . . . Gate Terminal
18 . . . Three-Pin Terminal
20 . . . Power Module
21 . . . Base Plate
22 . . . Mount Surface
23 . . . Radiator
30 . . . Resistance-Welder Power Source
31 . . . Control Module
311 . . . CPU
312 . . . Current Measurement Unit
313 . . . Power Circuit
32 . . . Operation Panel
33 . . . AC Power Source
34 . . . Switch
351 . . . Power Supply Bar
352 . . . Grounding Bar
361 . . . Power Supply Line
362 . . . Grounding Line

1. A resistance-welder power source for energizing a resistance welder, the power source comprising:
a) one or a plurality of lithium-based secondary batteries;
b) a charging circuit for charging the lithium-based secondary battery using an external power source; and
c) a power conversion circuit for converting DC power discharged from the lithium-based battery into DC or AC power having a predetermined level of maximum instantaneous power for energizing the resistance welder.

2. The resistance-welder power source according to claim 1, wherein the lithium-based secondary battery is a lithium polymer battery.

3. The resistance-welder power source according to claim 1, wherein a plurality of the lithium-based secondary batteries are connected in series or in parallel.

4. A resistance-welder power source, wherein a plurality of sets of the resistance-welder power sources according to claim 1 are connected in parallel.

5. A resistance welder, wherein the resistance-welder power source according to claim 1 is used as a power source.
